(19) United States
(12) Patent Application Publication
(10) Pub. No.: US 2023/0022165 A1
(43) Pub. Date: Jan. 26, 2023

(54) ELECTROMAGNETIC DEVICE FOR ELEVATOR BRAKE, ELEVATOR BRAKE AND ELEVATOR SYSTEM

(71) Applicant: Otis Elevator Company, Farmington, CT (US)

(72) Inventors: Guochen Gao, Tianjin (CN); Yuwei Shen, Tianjin (CN); Xin Xi, Tianjin (CN)

(21) Appl. No.: 17/825,753

(22) Filed: May 26, 2022

(30) Foreign Application Priority Data
Jul. 20, 2021 (CN) 202110818729.X

(51) Int. Cl. B66B 1/36; B66B 5/02

(52) U.S. Cl. CPC B66B 1/36; B66B 5/02

(57) ABSTRACT

An electromagnetic device for an elevator brake, an elevator brake and an elevator system. The electromagnetic device is configured to be provided in the number of at least two in the elevator brake, and each of the electromagnetic devices includes: a fixed member, which is fixed relative to an elevator power device and provided with at least one electromagnetic member for providing an electromagnetic force after being energized; a movable member, which is arranged between the fixed member and a friction member of the elevator brake, and arranged to be movable relative to the fixed member; and a force supply member, which is arranged to provide a force in an opposite direction to the electromagnetic force to the movable member.

### FOREIGN PRIORITY

This application claims priority to Chinese Patent Application No. 202110818729.X filed Jul. 20, 2021, and all the benefits accruing therefrom under 35 U.S.C. § 119, the contents of which in its entirety are herein incorporated by reference.

### FIELD OF THE INVENTION

The present disclosure relates to the technical field of elevators. More specifically, the present disclosure relates to an electromagnetic device for an elevator brake, an elevator brake and an elevator system.

### BACKGROUND OF THE INVENTION

An elevator brake is a safety braking device in an elevator, and it plays a key role in ensuring a safe operation of the elevator and personal safety of passengers. In practical applications, an elevator power device such as a traction machine, the elevator brake, etc., can be installed in suitable locations such as an elevator machine room, and then the elevator power device can be connected to an elevator car by ropes to provide power to the elevator car, driving the elevator car to move up and down in an elevator hoistway; the elevator brake is operated to make the elevator car stop at a target floor that the passenger wants to go to. In addition, when an abnormal situation such as equipment failure or emergency accident occurs, the elevator car can be safely braked through the elevator brake.

At present, many types of elevator brake products have been provided in the industry, many of which have adopted a configuration with components such as a movable plate, a static plate, and an electromagnetic coil, so as to provide operational functions such as the above-mentioned braking (or braking releasing) of the elevator brake when needed. However, the present application has found that such existing elevator brakes have defects and deficiencies. For example, they are usually large in overall structure, limited in design space and inflexible in location layout, and they are not easy to manufacture, transport, install, and maintain. Moreover, it may be difficult to meet more comprehensive, higher or newer application requirements in terms of working performance, system redundancy, safety and reliability, etc.

### SUMMARY OF THE INVENTION

In view of the foregoing, the present disclosure provides an electromagnetic device for an elevator brake, an elevator brake, and an elevator system, so as to solve or at least alleviate one or more of the above problems and other problems in the prior art, or to provide alternative technical solutions for the prior art.

Firstly, according to an aspect of the present disclosure, an electromagnetic device for an elevator brake is provided, the electromagnetic device being configured to be provided in the number of at least two in the elevator brake, and each of the electromagnetic devices includes: a fixed member, which is fixed relative to an elevator power device and provided with at least one electromagnetic member for providing an electromagnetic force after being energized; a movable member, which is arranged between the fixed member and a friction member of the elevator brake, and arranged to be movable relative to the fixed member; and a force supply member, which is arranged to provide a force in an opposite direction to the electromagnetic force to the movable member, so that when the elevator brake is in a first state, the movable member is driven by the force to move toward the friction member and bring the friction member into contact with the elevator power device to provide a braking force for stopping an elevator car, and when the elevator brake is in a second state, the electromagnetic force is provided to overcome the force to urge the movable member to move toward the fixed member so that the friction member is out of contact with the elevator power device.

In the electromagnetic device for the elevator brake according to the present disclosure, optionally, the electromagnetic device further includes a damper arranged between the fixed member and the movable member.

In the electromagnetic device for the elevator brake according to the present disclosure, optionally, the electromagnetic member includes an electromagnetic coil arranged such that an angle between a central axis of the electromagnetic coil and a central axis of the friction member is in a range of 0°-90°.

In the electromagnetic device for the elevator brake according to the present disclosure, optionally, the fixed member is provided with at least two electromagnetic coils, which are symmetrically arranged on the fixed member.

In the electromagnetic device for the elevator brake according to the present disclosure, optionally, the fixed member is provided with an accommodation portion, and the electromagnetic coil is wound or sleeved on the accommodation portion.

In the electromagnetic device for the elevator brake according to the present disclosure, optionally, the accommodation portion is arranged on a middle section or two side sections of the fixed member, and the electromagnetic coil is configured into a circular shape, an elliptical shape or a polygonal shape.

In the electromagnetic device for the elevator brake according to the present disclosure, optionally, the fixed member is fixedly connected to the elevator power device after passing through the movable member via a connector.

In the electromagnetic device for the elevator brake according to the present disclosure, optionally, a guide bushing is provided between the connector and the movable member.

In the electromagnetic device for the elevator brake according to the present disclosure, optionally, the fixed member and the movable member are configured into an I-shape, a V-shape, or a U-shape.

In the electromagnetic device for the elevator brake according to the present disclosure, optionally, the movable member is configured into a flat plate shape.

In the electromagnetic device for the elevator brake according to the present disclosure, optionally, the force supply member includes a spring arranged between the fixed member and the movable member.

Secondly, according to another aspect of the present disclosure, an elevator brake is also provided, which includes at least two electromagnetic devices for the elevator brake as described in any one of the above, in which the electromagnetic device is arranged such that in the first state, the force provided by the force supply member drives the movable member to move toward the friction member and brings the friction member into contact with the elevator power device to provide a braking force for stopping the elevator car, and that in the second state, the electromagnetic force is provided to overcome the force to urge the movable member to move toward the fixed member, so that the friction member is out of contact with the elevator power device.

In the elevator brake according to the present disclosure, optionally, the electromagnetic devices are all arranged in a plane parallel to an outer surface of the friction member that is adjacent to the movable member, and are arranged evenly in a circumferential direction of the friction member.

In the elevator brake according to the present disclosure, optionally, the elevator brake includes at least two electromagnetic devices that are different from each other.

In addition, according to further another aspect of the present disclosure, an elevator system is also provided, which includes the elevator brake as described in any one of the above.

From the following detailed description combined with the accompanying drawings, the principles, characteristics, features, advantages and the like of the technical solutions according to the present disclosure will be clearly understood. The electromagnetic device provided according to the present disclosure can be widely used in various elevator brakes. The electromagnetic device is not only compact in structure, small in space and low in cost, but also is easy to manufacture, transport, install and maintain, which makes it especially convenient to perform on-demand flexible layout on the elevator brake, and can effectively improve and perfect the performances of the elevator brake and the elevator system, and fully meet different application requirements.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structural configurations described herein, and are not required to be drawn to scale.

FIG. 1 is a schematic view of a three-dimensional structure after installation and connection of an example of an elevator brake and an example of an elevator power device, with two first embodiments of an electromagnetic device according to the present disclosure being provided in the example of the elevator brake.

FIG. 2 is a schematic front view of the structure of the example of FIG. 1.

FIG. 3 is a schematic view of a three-dimensional structure of the first embodiment of the electromagnetic device in the example of FIG. 1.

FIG. 4 is a schematic view of an exploded structure of the first embodiment of the electromagnetic device shown in FIG. 3.

FIG. 5 is a schematic view of a working principle of the embodiment of the electromagnetic device according to the present disclosure.

FIG. 6 is a schematic view of a three-dimensional structure of a second embodiment of the electromagnetic device according to the present disclosure.

FIG. 7 is a schematic front view of the structure after two second embodiments of the electromagnetic device shown in FIG. 6 are installed to the example of the elevator brake and the example of the elevator power device.

FIG. 8 is a schematic view of a three-dimensional structure of a third embodiment of the electromagnetic device according to the present disclosure.

FIG. 9 is a schematic front view of the structure after the example of the elevator brake having two third embodiments of the electromagnetic device shown in FIG. 8 is installed and connected to the example of the elevator power device.

FIG. 10 is a schematic view of a three-dimensional structure of a fourth embodiment of the electromagnetic device according to the present disclosure.

FIG. 11 is a schematic view of a three-dimensional structure of a fifth embodiment of the electromagnetic device according to the present disclosure, in which a movable member is not shown.

FIG. 12 is a schematic view of an exploded structure of a sixth embodiment of the electromagnetic device according to the present disclosure.

FIG. 13 is a schematic view of a three-dimensional structure of a seventh embodiment of the electromagnetic device according to the present disclosure.

FIG. 14 is a schematic view of an exploded structure of the seventh embodiment of the electromagnetic device shown in FIG. 13.

FIG. 15 is a schematic view of a three-dimensional structure of an eighth embodiment of the electromagnetic device according to the present disclosure.

FIG. 16 is a schematic view of an exploded structure of the eighth embodiment of the electromagnetic device shown in FIG. 15.

### DETAILED DESCRIPTION OF THE EMBODIMENT(S) OF THE INVENTION

First, it should be noted that the structures, components, characteristics, advantages and the like of the electromagnetic device for an elevator brake, the elevator brake and the elevator system according to the present disclosure will be described below by way of example. However, it should be understood that neither of the descriptions should be understood as limiting the present disclosure in any way.

In addition, for any single technical feature described or implied in the embodiments mentioned herein or any single technical feature shown or implied in individual drawings, the present disclosure still allows for any combination or deletion of these technical features (or equivalents thereof) without any technical obstacle. Therefore, it should be considered that these more embodiments according to the present disclosure are also within the scope recorded in this document. In addition, for the sake of brevity, general items commonly known to those skilled in the art, such as the basic principles of the elevator power device, electromagnetic force, and electromagnetic field will not be described in greater detail herein.

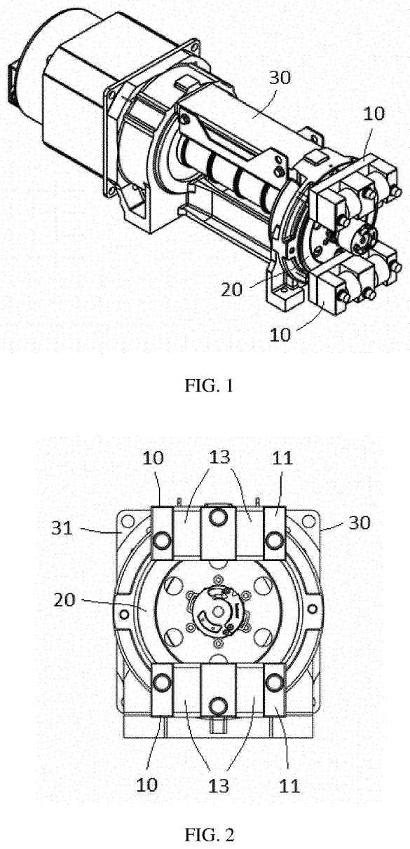

First, reference is made to the examples given in FIGS. 1 to 4, which respectively show a specific structural configuration of a first embodiment of an electromagnetic device according to the present disclosure, and a situation in which two such first embodiments of the electromagnetic device are installed in an example of an elevator brake at the same time, and then the example of the elevator brake and an example of an elevator power device are installed and connected.

As shown in the above drawings, in the example of the elevator brake, each electromagnetic device 10 may be provided with a fixed member 11, a movable member 12, an electromagnetic member 13 and a force supply member 14. The fixed member 11 may be fixed relative to an elevator power device 30. For example, optionally, the fixed member 11 may be directly installed and connected to a housing 31 of the elevator power device 30 (such as a traction machine), an internal frame or any other suitable structure through one or more connectors 15 such as bolts, so that the fixed member 11 can remain stationary relative to the elevator power device 30.

According to different application situations, the fixed member 11 may be configured into any feasible shape and structure, and one or more electromagnetic members 13 may be arranged on the fixed member 11, so that an electromagnetic field is formed when needed by supplying power to the electromagnetic member 13 to provide an electromagnetic force F2, which will be applied to the movable member 12; a description in this regard will be given later.

As an illustrative example only, in this embodiment, the fixed member 11 and the movable member 12 in the electromagnetic device 10 may be configured into an I-shaped structure as a whole, and the two electromagnetic members 13 may be installed on two side sections of the fixed member 11 respectively. Generally speaking, in the various embodiments according to the present disclosure, the electromagnetic member 13 can take the form of an electromagnetic coil very conveniently; for example, electromagnetic coils with shapes such as a circle, an ellipse, a polygon (such as a triangle, a rectangle, a square, a rhombus, and a pentagon) that meet specific application requirements may be selected and used. In practical applications, the electromagnetic coils may be formed by directly wounding on the fixed member 11, or pre-fabricated electromagnetic coils may also be installed on the fixed member 11. These electromagnetic coils may form a symmetrical or asymmetrical overall layout on the fixed member 11. Of course, the present disclosure also allows the electromagnetic members 13 to take any other form of electromagnetic components, modules or devices capable of outputting an electromagnetic force after being energized, which will not be described in detail herein.

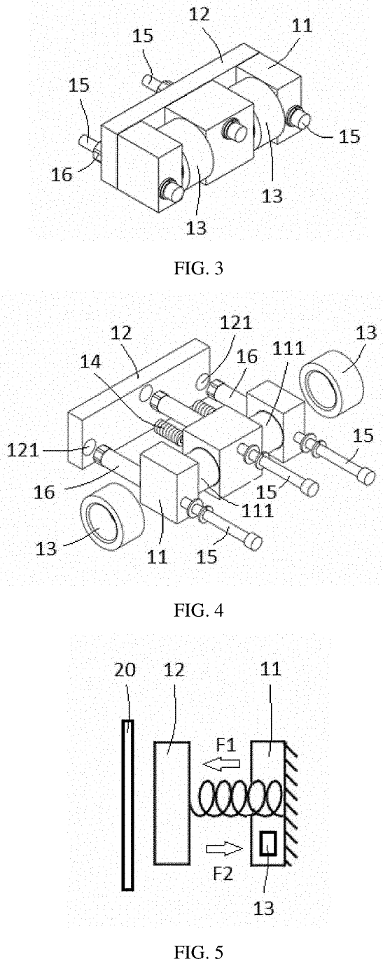

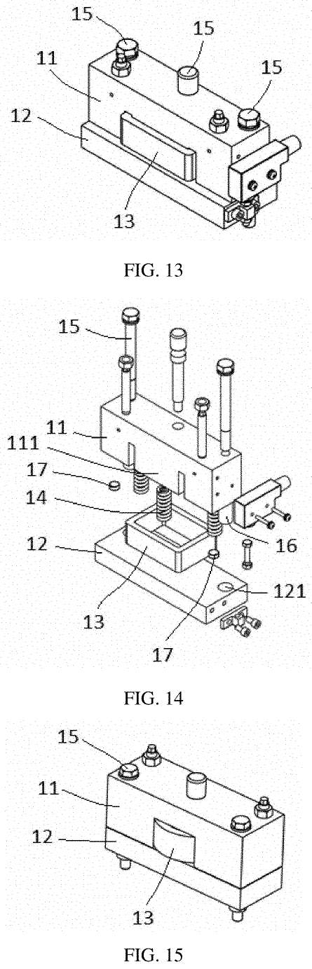

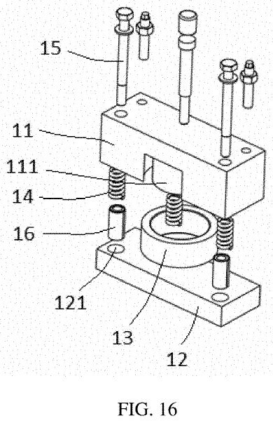

Referring to FIGS. 3 and 4, an accommodation portion 111 may be provided on the fixed member 11 to allow the electromagnetic members 13 to be arranged in place on the fixed member 11. With regard to the specific shape and size of the accommodation portion 111, the present disclosure does not impose any restrictions. For example, the accommodation portion 111 may be optionally configured into a cylindrical shape as shown in FIG. 4, so that the two electromagnetic members 13 can be respectively wound or sleeved on the accommodation portion 111; in this case, respective central axes of them are all perpendicular to a central axis of a friction member 20. For another example, the accommodation portion 111 can be optionally configured to have a recessed structure matching the electromagnetic member 13 in the middle as shown in FIGS. 13 to 16, so that the electromagnetic member 13 can be arranged in the recessed structure. It can be understood that the specific structural form of the above-mentioned recessed structure can be set according to the situation of the electromagnetic member 13. For example, the recessed structure may have a planar structure, a circular arc surface structure, or a more complicated structure, etc.

Next, reference is made to FIGS. 1 to 4, in the given electromagnetic device 10, the movable member 12 is arranged between the fixed member 11 and the friction member 20 of the elevator brake, and the movable member 12 can move relative to the fixed member 11. For example, under the actions of a force F1 provided by the force supply member 14 and a force F2 provided by the electromagnetic member 13 after being energized, the movable member 12 moves in opposite directions relative to the fixed member 11.

As an example, the fixed member 11 may be fixedly connected to the elevator power device 30 via the connector 15, and the connector 15 will pass through a through hole 121 on the movable member 12. In an optional situation, a guide bushing 16 may be provided between the connector 15 and the movable member 12, so as to better play a role in guiding, protecting, etc. According to different application requirements, the arrangement positions, numbers, sizes, models, materials used and the like of the above-mentioned connector 15, guide bushing 16, etc., are allowed to be flexibly selected and adjusted. For example, in some embodiments, several connectors 15 that are completely the same may be used at the same time, and in other embodiment, several connectors 15 that are not completely the same may be used. Corresponding demonstrations are also shown in different drawings of the present disclosure.

In addition, in some alternative embodiments, a damper 17 may be further provided in the electromagnetic device 10. The damper 17 may be made of an elastic material such as rubber, and may be arranged between the fixed member 11 and the movable member 12 so that when the movable member 12 moves relative to the fixed member 11 and comes into contact with it, possible influences in terms of vibration, impact, and noise can be effectively reduced or eliminated. This is advantageous for long-term reliable use of the fixed member 11, the movable member 12, the electromagnetic member 13 and the like in the electromagnetic device 10, and even the elevator brake, the elevator power device and the like that are associated with the electromagnetic device 10. In practical applications, one, two or more dampers 17 can be provided; for example, one end of the damper 17 can be fixed to the fixed member 11 and/or the movable member 12, and the specific arrangement positions of these dampers 17 can be set as required.

Reference is made to FIG. 5 again, in which the basic working principle of an embodiment of the electromagnetic device according to the present disclosure is only schematically shown. As shown in FIG. 5, the force supply member 14 may take the form of one or more springs. For example, it can be optionally arranged between the fixed member 11 and the movable member 12 to provide a force F1 to the movable member 12 so that the movable member 12 can be driven to move toward the friction member 20 (that is, away from the fixed member 11); therefore, the friction member 20 can be made in contact with the elevator power device 30 (more specifically, a braking member used for the elevator power device 30, such as a rotating wheel, a turntable) and provide a braking force, so that the elevator power device 30 can stop outputting power to achieve the purpose of safe braking of the elevator car. At this time, the elevator brake is in the first state, which is often referred to as a braking state or closed state in the industry.

In addition, the electromagnetic member 13 in the electromagnetic device 10 can be used to output an electromagnetic force F2 outward when needed in a direction opposite to the force F1 after being energized, so as to overcome the force F1 applied by the force supply member 14 to the movable member 12 by providing the electromagnetic force F2, thereby urging the movable member 12 to move away from the friction member 20 (that is, toward the fixed member 11), causing the friction member 20 to be out of contact with the elevator power device 30, and therefore restoring the power output of the elevator power device 30 to the elevator car. At this time, the elevator brake is in a second state different from the above-mentioned first state, so that the elevator car can resume running.

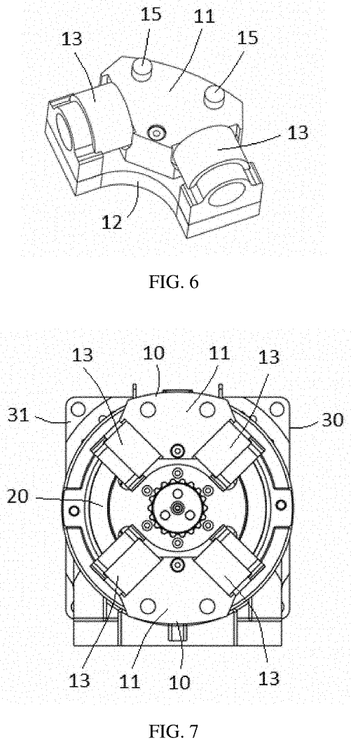

Next, reference is made to FIGS. 6 to 16, which further illustrate more different embodiments of the electromagnetic device for the elevator brake according to the present disclosure. For these embodiments, unless specifically described herein, the above description of the first embodiment of the electromagnetic device is also applicable to these different embodiments.

For example, first of all, in the embodiment shown in FIGS. 6 and 7, the electromagnetic device 10 may be optionally configured to be substantially V-shaped; at this time, two electromagnetic members 13 may be installed on both sides of the fixed member 11 in the electromagnetic device 10 for example in a left-and-right symmetrical arrangement, and two such electromagnetic devices 10 may be arranged at upper and lower positions of the elevator brake respectively, so that they are used to realize functions of the elevator brake such as braking control operation or braking releasing control operation.

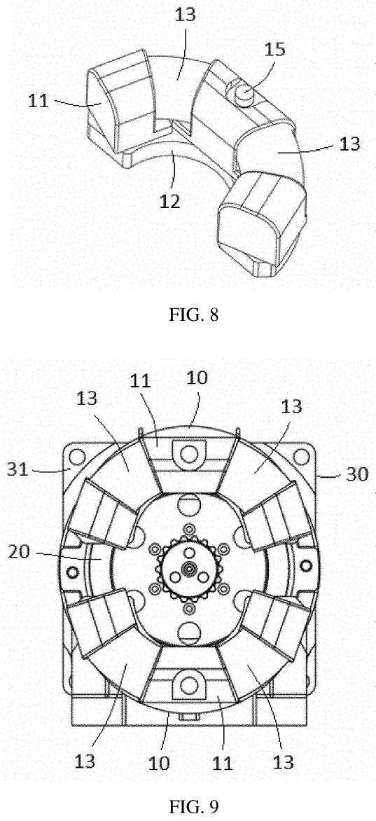

As another example, as shown in FIGS. 8 and 9, in some embodiments, the electromagnetic device 10 may be configured to be substantially U-shaped; at this time, it may optionally substantially correspond to part of an outer profile of the friction member 20. For example, as shown in FIG. 9, two such U-shaped electromagnetic devices 10 may be arranged at upper and lower positions of the elevator brake to realize corresponding operation functions of the elevator brake.

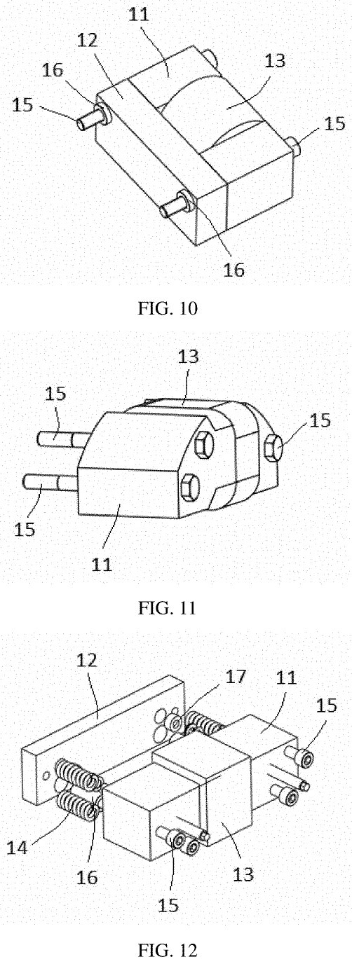

In addition, as shown in FIGS. 10 to 16, in some embodiments, it may be considered to provide only one electromagnetic member 13 in the electromagnetic device 10. For example, it may be optionally arranged in the middle position of the fixed member 11. At this time, the structure is simpler and more compact, and the space layout is more convenient and flexible. In a case where the electromagnetic device 10 has a single electromagnetic member 13, although two such electromagnetic members 13 are mostly arranged in the elevator brake, it should be understood that arranging three, four or more such electromagnetic members 13 in the elevator brake at the same time is also feasible in the solution of the present disclosure.

For different application occasions, the present disclosure not only allows the electromagnetic member 13 to be arranged such that its central axis and the central axis of the friction member 20 are perpendicular to each other as shown in FIG. 10, 11 or 12, but also allows the electromagnetic member 13 to be arranged such that its central axis and the central axis of the friction member 20 are parallel with each other as shown in FIGS. 13, 14, 15 and 16. It should be understood that the present disclosure actually allows the electromagnetic member 13 to be arranged such that the angle between its central axis and the central axis of the friction member 20 is in a range of 0°-90° according to application requirements. For the sake of convenience, in the given embodiment, only a situation in which a parallel relationship (that is, corresponding to 0°) or a vertical relationship (that is, corresponding to 90°) is formed is exemplarily shown. In addition, the specific number of the electromagnetic devices 10 equipped in a specific elevator brake and the specific number of the electromagnetic members 13 provided in any one of the electromagnetic devices 10 may be set according to application requirements.

As described above, different from the prior art, the solution according to the present disclosure can provide maximum flexibility for the spatial arrangement, electromagnetic force control, redundant design and the like of the electromagnetic member 13, which will be very advantageous for fully adapting to and satisfying the design requirements of different types of elevator brakes, and effectively improving and enhancing the performance of the elevator brake in terms of system redundancy, safety and reliability, etc.

In addition, it has to be pointed out that in the electromagnetic device for the elevator brake according to the present disclosure, it is allowed to configure components therein (such as the fixed member, the movable member, the force supply member, etc.) to have any feasible structural configuration according to actual requirements; for example, the movable member 12 can be configured into a suitable shape such as a flat plate, and the present disclosure does not impose any specific restrictions on this.

It can be understood that since the electromagnetic device according to the present disclosure can be formed as a modular independent unit, it can be separately manufactured, used, sold, and so on. It not only has a compact structure, is very convenient to manufacture, transport, install and maintain, but also has a low overall cost, making it is very suitable for promotion and application in the elevator field. For example, once a certain electromagnetic device in the elevator brake is found to have failed during use, a new electromagnetic device can be used very conveniently, quickly, and at a low cost to replace the local electromagnetic device that has failed, without replacing the entire movable plate, static plate and/or electromagnetic coil in the elevator brake as in the prior art.

As another aspect of the present disclosure that is significantly superior to the prior art, an elevator brake is also provided, in which two, three or more electromagnetic devices such as those above-discussed according to the present disclosure can be provided at the same time.

As mentioned above, a required number of electromagnetic devices 10 may be installed in the elevator brake according to the application requirements, so that when the elevator brake is in the first state, the force F1 provided by the force supply member 14 can be used to drive the movable member 12 to move toward the friction member 20, and to make the friction member 20 contact the elevator power device 30 to provide a braking force to stop the elevator car; in addition, when the elevator brake is in the second state, the electromagnetic force F2 provided by the electromagnetic member 13 in the electromagnetic device 10 can be used to overcome the force F1, thereby urging the movable member 12 to move toward the fixed member 11, so that the friction member 20 can be made out of contact with the elevator power device 30; that is, at this time, the previous braking state is released at this time and the elevator car is allowed to resume operation.

It should be pointed out that the specific arrangement positions and the number of the electromagnetic devices 10 in the elevator brake can be selected and set according to actual needs, and they are not limited to for example the one or two electromagnetic devices exemplarily shown in the drawings of the present disclosure. For example, in some application occasions, three, four or more electromagnetic devices may be arranged at the same time, which can provide better system redundancy and ensure the safety performance of the elevator brake and the elevator system. When a plurality of electromagnetic devices 10 respectively provide a corresponding electromagnetic force F2, these electromagnetic forces F2 will form a final resultant effect on the friction member 20 through the respective movable members 12, thereby realizing the corresponding operations of the elevator brake, such as braking control operation, braking releasing control operation, etc.

In a specific application, these electromagnetic devices 10 may be simultaneously arranged in parallel in a plane parallel to an outer surface of the friction member 20 that faces the movable member 12, and the electromagnetic devices 10 may be arranged evenly in a circumferential direction of the friction member 20, which will help provide an overall uniform electromagnetic force, and promote the working performance of the elevator brake to be more stable and reliable.

It should also be understood that although in the examples given in the drawings, it is shown that a number of electromagnetic devices 10 identical to each other are equipped in the elevator brake, which is advantageous for the operation of equipment procurement, installation and maintenance as well as for optimizing the overall performance of the elevator brake, etc., the present disclosure still allows two or more electromagnetic devices 10 that are different from each other to be arranged in one elevator brake at the same time. For example, two of the electromagnetic devices may have different sizes or structures. For example, one electromagnetic device has a V-shape, and the other electromagnetic device has a U-shape. For another example, one electromagnetic coil may be arranged in one electromagnetic device, and two electromagnetic coils may be arranged in the other electromagnetic device.

According to the technical solution of the present disclosure, an elevator system is also provided, in which the elevator brake designed and provided according to the present disclosure can be arranged in the elevator system, so as to solve or eliminate the above mentioned existing defects and deficiencies in the existing elevator brakes; especially, in such aspects as space design and layout, electromagnetic force control, redundancy, safety and reliability, the performance of the elevator brake can be further optimized and improved, thereby enhancing the product quality of the elevator system.

The electromagnetic device for the elevator brake, the elevator brake and the elevator system according to the present disclosure have been elaborated above in detail by way of example only. These examples are merely used to illustrate the principles and embodiments of the present disclosure, rather than limiting the present disclosure. Various modifications and improvements can be made by those skilled in the art without departing from the spirit and scope of the present disclosure. Therefore, all equivalent technical solutions should fall within the scope of the present disclosure and be defined by the claims of the present disclosure.

What is claimed is:

1. An electromagnetic device for an elevator brake, wherein the electromagnetic device is configured to be provided in the number of at least two in the elevator brake, and each of the electromagnetic devices comprises:
a fixed member, which is fixed relative to an elevator power device and provided with at least one electromagnetic member for providing an electromagnetic force after being energized;
a movable member, which is arranged between the fixed member and a friction member of the elevator brake, and arranged to be movable relative to the fixed member; and
a force supply member, which is arranged to provide a force in an opposite direction to the electromagnetic force to the movable member, so that when the elevator brake is in a first state, the movable member is driven by the force to move toward the friction member and bring the friction member into contact with the elevator power device to provide a braking force for stopping an elevator car, and when the elevator brake is in a second state, the electromagnetic force is provided to overcome the force to urge the movable member to move toward the fixed member so that the friction member is out of contact with the elevator power device.

2. The electromagnetic device for an elevator brake according to claim 1, wherein the electromagnetic device further comprises a damper arranged between the fixed member and the movable member.

3. The electromagnetic device for an elevator brake according to claim 1, wherein the electromagnetic member comprises an electromagnetic coil arranged such that an angle between a central axis of the electromagnetic coil and a central axis of the friction member is in a range of 0°-90°.

4. The electromagnetic device for an elevator brake according to claim 3, wherein the fixed member is provided with at least two electromagnetic coils, which are symmetrically arranged on the fixed member.

5. The electromagnetic device for an elevator brake according to claim 3, wherein the fixed member is provided with an accommodation portion and the electromagnetic coil is wound or sleeved on the accommodation portion.

6. The electromagnetic device for an elevator brake according to claim 5, wherein the accommodation portion is arranged on a middle section or two side sections of the fixed member, and the electromagnetic coil is configured into a circular shape, an elliptical shape or a polygonal shape.

7. The electromagnetic device for an elevator brake according to claim 1, wherein the fixed member is fixedly connected to the elevator power device after passing through the movable member via a connector.

8. The electromagnetic device for an elevator brake according to claim 7, wherein a guide bushing is provided between the connector and the movable member.

9. The electromagnetic device for an elevator brake according to claim 1, wherein the fixed member and the movable member are configured into an I-shape, a V-shape, or a U-shape.

10. The electromagnetic device for an elevator brake according to claim 1, wherein the movable member is configured into a flat plate shape.

11. The electromagnetic device for an elevator brake according to claim 1, wherein the force supply member comprises a spring arranged between the fixed member and the movable member.

12. An elevator brake, comprising at least two electromagnetic devices for the elevator brake according to claim 1, wherein the electromagnetic device is arranged such that in the first state, the force provided by the force supply member drives the movable member to move toward the friction member and brings the friction member into contact with the elevator power device to provide a braking force for stopping the elevator car, and that in the second state, the electromagnetic force is provided to overcome the force to urge the movable member to move toward the fixed member, so that the friction member is out of contact with the elevator power device.

13. The elevator brake according to claim 12, wherein the electromagnetic devices are all arranged in a plane parallel to an outer surface of the friction member that is adjacent to the movable member, and are arranged evenly in a circumferential direction of the friction member.

14. The elevator brake according to claim 12, wherein the elevator brake comprises at least two electromagnetic devices that are different from each other.

15. An elevator system, comprising the elevator brake according to claim 12.
